(19) United States
(12) Patent Application Publication
(10) Pub. No.: US 2007/0041884 A1
(43) Pub. Date: Feb. 22, 2007

(54) Resin and process for extracting non-ferrous metals

(75) Inventor: Nikolai Zontov, Keysborough (AU)

Correspondence Address: MERCHANT & GOULD PC, P.O. BOX 2903, MINNEAPOLIS, MN, 55402-0903, US

(73) Assignee: CLEAN TEQ PTY LTD, VICTORIA (AU)

(21) Appl. No.: 10/556,332

(22) PCT Filed: May 7, 2004
(86) PCT No.: PCT/AU04/00605

§ 371 Date: Sep. 5, 2006

(30) Foreign Application Priority Data
May 9, 2003 (AU) 2003902237

(51) Int. Cl. C22B 3/42; C22B 23/00; B01J 39/20

(52) U.S. Cl. 423/139; 423/59; 521/38

(57) ABSTRACT

A process is provided for the direct recovery of non-ferrous metals (nickel, cobalt, copper etc) from raw materials such as ores, concentrates, semiproducts and/or solutions by ion exchange. A non-ferrous ore or concentrate is leached with a mineral acid to dissolve the metals. The pH of the resulting leach slurry is adjusted to 1.0-5.0 using some alkaline agents as limestone, sodium hydroxide etc. Non-ferrous metals are absorbed from this leach slurry with ion-exchange resin, which selectively loads the non-ferrous metals and has the structure: 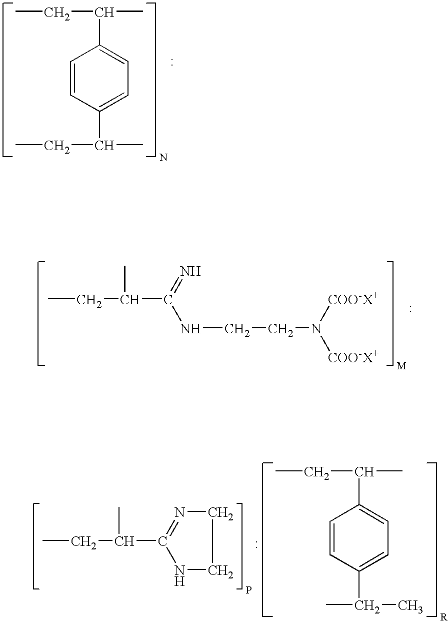 wherein the ratio of N : M : P : R is within the ranges of 3-4: 64-70:25-30:2-2.5 The loaded resin is separated from the exhausted leach slurry. The loaded sorbent is stripped with an acidic or ammonia-ammonium carbonate solution. The stripped resin is returned to the loading cycle. The non-ferrous metal can be recovered in substantially pure from the eluate by some known processes. The metal-depleted slurry proceeds to waste treatement and disposal.

### FIELD OF THE INVENTION

The present invention relates to an ion-exchange resin and a hydrometallurgical process for extracting non-ferrous metals from raw materials including ores, concentrates, semiproducts, solutions, pulps and slurries. The ion-exchange resin and process of the present invention can be used to extract non-ferrous metals that include but is not limited to nickel, cobalt and copper.

### BACKGROUND TO THE PRESENT INVENTION

Hydrometallurgical processes for extracting non-ferrous metals from ores and concentrates using ion-exchange resins normally includes a leaching step whereby valuable metals are leached by a mineral acid solution to form a leach slurry. The slurry is then fed to a solid/liquid separator from which a solid phase and a clear pregnant liquid phase are discharged. The liquid phase is subsequently contacted with an ion-exchange resin in a metal recovery step. Hitherto the solid/liquid separation step has proven to be problematic for a number of reasons that stem from solid phase having a very fine size distribution. This characteristic together with the selective separation of the impurities from the valuable metal adds cost and complexity to the extraction processes.

The fineness and behaviour of the leach slurry makes traditional filtration techniques unsuitable for the solid/liquid separation step.

One type of solid/liquid separator that has been developed for handling finer particles is counter/current decantation (CCD) circuit. A CCD circuit often includes a series of 6-9 thickeners, each in excess of 50 metres in diameter in order to minimise metal losses and produce a clear pregnant leach liquid phase. However a difficulty in using a CCD circuit is that low levels of recovery may be obtained when the leach slurry being treated has poor settling characteristics.

Another problem is the relatively high capital and operational costs of CCD circuits. Operational costs include power consumption of a CCD rake mechanism, water and flocculent consumption added to the CCD thickeners. The flocculent consumption often ranges from 200 to over 800 gms per tonne of solid extracted and may account for up to 10% of the total plant operating costs.

In an attempt to alleviate these shortcomings, an improved process for extracting nickel and cobalt from an oxide ore leach slurry is described in U.S. Pat. No. 6,350,420. The US patent describes a process in which nickel and cobalt are extracted from nickeliferous and/or cobaltiferous oxide ores, pulps or slurries by direct ion exchange.

Specifically, the process includes leaching valuable metals from nickeliferous ore using mineral acid to form a pregnant leach slurry containing nickel, cobalt and a mixture of impurities such as copper, iron, chromium, magnesium and manganese. The pregnant leach slurry is contacted with an ion-exchange resin and thereby selectively loads nickel and cobalt from the slurry in a sorption extraction stage. Either before or during the sorption/extraction stage, the pH of the slurry may be adjusted by the addition of a neutralising agent.

An advantage of the process described in the US patent is that valuable metals are extracted from leach slurry rather than from a clear pregnant leach solution and, therefore, avoids the difficulties of solid/liquid separation steps of the traditional extraction processes.

The ion-exchange resin described in the US patent contains a functional group selected from the group consisting of 2-picolylamine, bis- (2-picolyl)-amine, N-methyl-2-picolylamine, N-(2-hydroxyethyl)-2-picolylamine and N-(2-hydroxypropyl)-2-picolylamine and mixtures thereof.

The resin is separated from the leach residue slurry by screening. The loaded resin is stripped using acidic solution (0.5-5M) or an ammoniacal solution. After desorption, the resin is returned to the loading cycle. The metal depleted slurry proceeds to disposal.

The following table provides nickel concentrations in the leachate and eluate according to the process described in the US patent.

TABLE
Nickel concentration (g/L)

| | Example | | |
|---|---|---|---|
| | 1 | 2 | 3 |
| Leachate | 4.19 | 11.0 | 5.59 |
| Eluate | 2.83 | 1.38 | 5.08 |

### SUMMARY OF THE INVENTION

According to the present invention there is provided an ion-exchange resin suitable for the hydro-extracting non-ferrous metals from raw materials that include ores, concentrates, semiproducts, solutions, pulps and slurries, the resin having the structure:

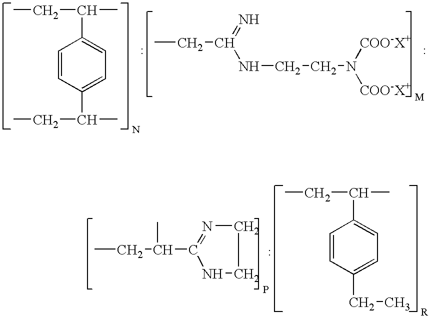

wherein the ratio of N:M:P:R is within the ranges of 3-4:64-70:25-30:2-2.5 respectively and X⁺ denotes a cation.

According to the present invention there is also provided an ion-exchange resin suitable for the hydro-extracting non-ferrous metals from raw materials that include ores, concentrates, semiproducts, solutions and slurries, the resin having the structure:

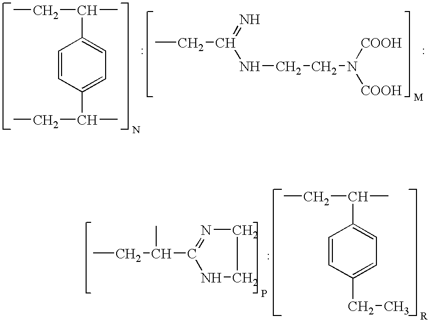

wherein the ratio of N:M:P:R is within the ranges of 3-4:64-70:25-30:2-2.5.

It is therefore within the scope of the present invention that the ratio of N:M:P:R may be either, although not exclusively:

i) 3:70:25:2; or

ii) 4:64:30:2.

According to the present invention there is also provided a process for hydro-extracting non-ferrous metals from a liquid; the process including the step of selectively sorbing non-ferrous metals from the liquid onto a resin, wherein the resin has the structure of the resin described above.

The liquid may be in any form including solutions formed in a processing plant such as tailing solutions. However, it is preferred that the liquid be a liquid phase of a pregnant slurry formed from ores, concentrates or any other product or semiproducts.

An advantage provided by the resin and process of the present invention is that the resin can be used to selectively sorb non-ferrous metals from the slurry without separating the solid and liquid phases to form a clear leach liquid phase from a leach slurry.

Although the non-ferrous metals may be lead, copper etc, it is preferred that the non-ferrous metal be nickel or cobalt or minerals containing these metals. It is also possible that the raw material be an oxide material, a sulphide material or an oxide-sulphide material.

It is preferred that the step of contacting the raw material with the resin to selectively sorb non-ferrous metal onto the resin be carried out at any suitable temperature up to the stability temperature of the resin approximately 100° C.

It is preferred that the process involves the step of leaching the raw material with a mineral acid or ammoniacal solution to dissolve the non-ferrous metals to form the pregnant slurry. The mineral acid may be sulphuric acid, hydrochloric acid, nitric acid and mixtures thereof. The leaching step can be carried out using any known technique including high pressure leaching, agitation leaching, heap leaching, atmospheric leaching, bio-oxidation leaching or a combination of these techniques.

In the situation when the raw material is an oxide material containing non-ferrous metals, it is preferred that the leaching step be carried out as either high pressure leaching, agitation leaching, heap leaching or atmospheric leaching.

In the situation when the raw material is a sulphide or mixed sulphide-oxide material containing non-ferrous metals, it is preferred that the leaching step be carried out as both mild temperature and mild pressure oxidation or bio-oxidation leaching.

It is preferred that the process include adjusting the pH of the pregnant leach slurry by adding an alkaline agent prior to or during the contact with the ion-exchange resin in order to optimise the sorption process. It is preferred that the pH of the slurry be in the range of 1.0 and 5.0.

It is even more preferred that the pH of the leach slurry be in the range of 3.5-4.5.

The alkaline agent may be either limestone, lime, alkali hydroxides, alkali carbonates, alkali bicarbonates, alkaline earth oxides, alkaline earth hydroxides, alkaline earth carbonates, alkaline earth bicarbonates or mixtures thereof.

Once the resin is loaded with non-ferrous metals, the resin may be washed with water to separate it from the residues of the slurry and then stripped. It is preferred that the process involves the step of stripping the resin of sorbent non-ferrous metals using acidic or ammoniacal solutions after separation from the exhausted leach slurry to form an eluate. The non-ferrous metal or its compound is recovered from the eluate by known processes.

In the situation when the stripping agent is an acid, it is preferred that the acid be either sulphuric acid, hydrochloric acid or nitric acid.

When the stripping agent is an acid, it is preferred that the concentration of the acid be in the range of 0.5M-5.0M.

In the situation when the stripping agent is an ammoniacal solution, it is preferred that the solution range from 15 to 25% ammonia and range from 15-25% carbon dioxide.

Once the resin has been stripped of non-ferrous metals it can be washed and reloaded with non-ferrous metals by returning the resin to the step of selectively sorbing non-ferrous metals onto the resin.

The present invention has the potential to revolutionise the overall scheme and processing plants for recovery of non-ferrous metals from ores, concentrates, semiproducts, solutions, pulps and slurries. Generally speaking the present invention allows the conventional CCD circuit to be replaced with a resin-in-pulp process. Furthermore, the present invention can be used to produce an eluate of such tenor and purity that the following advantages are available.

1. Downstream processing requirements would be greatly simplified.

2. The need for complicated recirculation circuits would be eliminated.

3. Total extraction rates provided by the present invention will at least match, and possibly exceed, those achieved using fully optimised conventional (CCD-based) processing schemes.

4. The nickel concentration can reach more than 40 g/L in resulting eluates. These solutions are suitable for the direct refinery of non-ferrous metals using well-known processes such as electrowinning, hydrogen reduction etc.

5. Capital intensity will be significantly reduced.

6. Operating cost will be lower.

### DETAILED DESCRIPTION

Embodiments of the present invention will now be described with reference to the following non-limiting examples. Each example has been carried out using an ion-exchange resin in accordance with the present invention.

### EXAMPLE 1

This example involved the extraction of nickel and cobalt from a test solution in the form of a tailing solution of a nickel/cobalt production plant.

The example was performed in a 700 ml-glass fixed-bed column containing an ion-exchange resin in accordance with the resin described above. The test solution was pumped into the top of the column such that it cascaded downwardly over the resin to collect at the bottom of the column. A peristaltic pump was used to pump the solution at the desired rate to the top of the column and a valve at the bottom of the column was used to control the rate at which barren solution was discharged from the column.

The test solution was pumped to the top of the column at 3-5 vol/vol/hr, or 2.1-3.5 L/hr for 40 hours and had a pH of about 5.5. Nickel concentrations in barren liquor discharged from the bottom of the column were monitored every 60 minutes until the nickel concentration exceeded a predetermined value, which, based on the concentration in the test solution in question was determined to be 200 ppm. Once the preselected value had been reached, the sorption extraction stage was complete.

After the sorption stage, an analysis of the resin showed that three-quarters of the resin ( i.e. 510 ml from the total 700 ml) was fully saturated.

The resin was then resined with water and further processed in a desorption stage in the same column by running a solution of 8% sulphuric acid through the column at rate of 0.5 vol/vol/hr or 250 ml/hr. The desorption stage was carried out for a period of 6 hours, consumed 1.5L of acid and produced an eluate solution that was drained from the base of the column.

Set out below in table 1 are the compositions of the test solution, barren solution and eluate solution.

TABLE 1
Metal elements in ppm

| | Test | Barren | Eluate |
|---|---|---|---|
| Metal Element | solution | solution | solution |
| Al | 0.02 | <0.01 | 0.80 |
| Co | 14.1 | 0.2 | 511 |
| Cr | 0.25 | 0.12 | 1.30 |
| Cu | 0.10 | 0.01 | 1.50 |
| Fe | <0.01 | <0.01 | 0.71 |
| Mg g/l | 22.3 | 20.4 | 2.83 |
| Mn | 815 | 336 | 1270 |
| Ni | 295 | 4.97 | 17 000 |
| Si | 17.5 | 15.3 | 7.30 |
| Zn | <0.01 | <0.01 | 9.56 |

The compositions shown in table 1 indicates that 98% of the incoming nickel and cobalt were removed from the test solution. The nickel concentration in the eluate was very high and reached 17g/L of nickel and 0.5 g/L of cobalt. The resin loading capacity reached 24.7 g/L of nickel and 0.76 g/L of cobalt.

The concentration of potential impurities was minimal and their impact is negligible.

### EXAMPLE 2

This example involved the extraction of nickel and cobalt from a high-pressure laterite leach slurry.

The leach slurry was prepared in a titanium autoclave at a temperature ranging from 220-230° C. with sulphuric acid solution. The pregnant leach slurry had a pH of about 0.8, a specific gravity of about 1.48 and a solids concentration of about 29.4 w/w %.

The pH of pregnant leach slurry was adjusted by adding a limestone pulp several hours before the extraction stages. The slurry after neutralisation had a pH of about 4.5 and a solids concentration of about 36.0 w/w %.

The first step of the metals extraction was then to feed the solution to an absorption circuit that comprised ten reactors connected in series. Each reactor was made of a borosilicate glass and housed a basket made of stainless steel mesh that containing about 100 mL of an ion-exchange resin in accordance with the resin described above. The slurry was conducted through the reactors, from reactor number 1 to reactor number 10 while the resin-filled baskets were transferred in counter current to the direction of the flow for the slurry from reactor number 10 to reactor number 1.

Fresh pregnant leach slurry was pumped into reactor number 1 by a peristaltic pump at a flow rate of about 0.6 L/hr which determined the speed of the slurry throughout the absorption circuit. The slurry was maintained at a temperature of approximately 60° C. and was mixed in the reactors by means of air agitation.

Throughout the process, the basket from reactor number 1 was periodically removed, and the fully loaded resin was washed with tap water and placed into the desorption column. The basket from reactor number 2 was moved to reactor number 1 and all the remaining baskets were moved to the preceding reactor in the direct of the flow of the slurry. A basket containing fresh resin was placed in reactor number 10.

The basket and resin removed from reactor 1 was treated in desorption stage which involved passing a solution of 12% hydrochloric acid through a 700 mL desorption fixed-bed column filled with loaded resin at rate 0.5 vol/vol/hr or 350 ml/hr Set out below in table 2 are the compositions of the test solution, barren solution and eluate solution.

TABLE 2
Elemental concentrations in ppm

| | Feed | Feed | Barren | Barren | |
|---|---|---|---|---|---|
| Elements | pulp(LP) | pulp(SP) | pulp(LP) | pulp(SP) | Eluate |
| Ni | 6780 | 1210 | 1.4 | 900 | 46 g/l |
| Co | 169 | 42 | −0.2 | 40 | 1210 |
| Fe | 0.6 | 19% | 0.4 | 19% | 14.4 |
| Mn | 1680 | 368 | 1390 | 350 | 1290 |
| Mg | 16400 | 0.09% | 12770 | 0.08% | 1070 |
| Cu | 0.2 | 52 | 0.1 | 42 | 98 |
| Zn | 22 | 60 | 0.1 | 46 | 74 |
| Al | 0.5 | 1% | 0.5 | 1% | 148 |
| Ca | 518 | 5.7% | 609 | 3.97% | 368 |
| Si | 51 | 19% | 40 | 19% | 17.5 |
| Cr | −0.2 | 8600 | −0.2 | 6950 | 1.34 |

(LP represents liquid phase)
(SP represents solid phase)

The results of example 2 have the following favourable outcomes:
(i) virtually complete extraction of nickel and cobalt from the liquid phases of the feed slurry, i.e. extraction rates up to 99.9% were achieved;
(ii) high resin loading for the targeted metals, i.e. up to 45g/L for nickel;
(iii) high concentrations of nickel and cobalt in the eluate solution, i.e. 46 g/L of nickel and 1.21 g/L of cobalt; and
(iv) low impurity levels.

### EXAMPLE 3

This example involves that extraction of copper from a copper rinsing solution. The copper concentration in the rinsing solution, prior to copper extraction, was in the range of 50-80 ppm.

The sorption stage was performed in a 4 L-glass moving-bed column filled with the ion-exchange resin. The rinsing solution was fed into the bottom of the column and discharged from the top at the rate of about 20 L/hr.

Resin moved in countercurrent to the solution and was fed into the top of the column and removed from the base in 10 mL batches every 2 hours.

The copper concentration in the exit solution was less than 0.02ppm. The resin loading capacity reached 20-32 g/l of copper depending on the copper concentration in the rinsing solution.

Desorption was performed by contacting the loaded resin with a 10% sulphuric acid solution. The copper concentration in the eluate reached 20-32 g/L.

It is envisaged that the eluate produced according to this example would be suitable feed for a copper-electroplating bath.

It will be appreciated by those skilled in the art of the present invention that many modifications and variations may be made to the Examples described above without departing from the spirit and scope of the present invention.

1. An ion-exchange resin suitable for the hydro-extracting non-ferrous metals from raw material that include but are not limited to ores, concentrates, semiproducts, solutions, pulps and slurries, the resin having the structure: 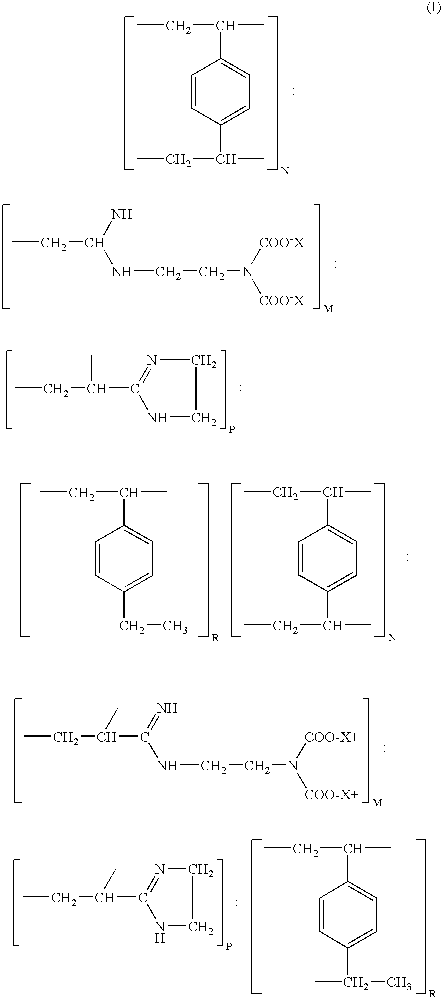
wherein the ratio of N:M:P:R is within the ranges of 3-4:64-70:25-30:2-2.5 respectively, and X⁺ denotes a cation.

2. An ion-exchange resin suitable for the hydro-extracting non-ferrous metals from raw material that include but are not limited to ores, concentrates, semiproducts, solutions, pulps and slurries, the resin having the structure: 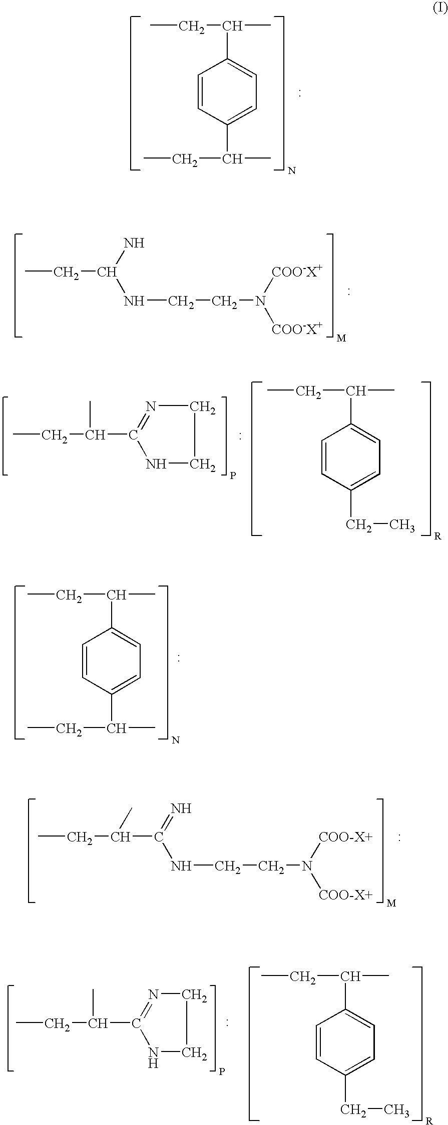
wherein the ratio of N:M:P:R is within the ranges of 3-4:64-70:25-30:2-2.5 respectively.

3. The ion-exchange resin according to claim 1, wherein the ratio of N:M:P:R is approximately 3:70:25:2 respectively.

4. The ion-exchange resin according to claim 1, wherein the ratio of N:M:P:R is approximately 4:64:30:2 respectively.

5. Use of the resin according to claim 1 in a process for the extraction of nickel, cobalt or copper or minerals containing these metals.

6. A process for hydro-extracting non-ferrous metals from a liquid, wherein the process includes a step of selectively sorbing non-ferrous metals from a liquid onto the resin according to claim 1.

7. The process according to claim 6, wherein the liquid is a liquid phase of pregnant leach slurry and the resin is used to selectively sorb non-ferrous metals directly from the slurry without a substantial solid/liquid separation pre-treatment step.

8. The process according to claim 6, wherein the non-ferrous metal is nickel, cobalt, copper or minerals containing these metals.

9. The process according to claim 6, wherein the step of selectively sorbing non-ferrous metal onto the resin is carried out at a temperature up to the stability temperature of the resin.

10. The process according to claim 9, wherein the temperature at which non-ferrous metals are sorbed onto the resin is at least 100° C.

11. The process according to claim 6, wherein the process further includes the step of leaching, with a mineral acid or ammoniacal solution, the non-ferrous metals from a solid raw material to form the pregnant slurry.

12. The process according to claim 11, whereby when the raw material is an oxide material containing non-ferrous metals, and the leaching step is either high pressure leaching, agitation leaching, heap leaching or atmospheric leaching.

13. The process according to claim 11, whereby when the raw material is a sulphide or mixed sulphide-oxide material containing non-ferrous metals, the leaching step is either mild temperature and mild pressure oxidation or bio-oxidation leaching.

14. The process according to claim 11, further including adjusting the pH of the pregnant leach slurry by adding an alkaline agent prior to or during the step of selectively sorbing non-ferrous metal onto the resin in order to optimise the sorption process.

15. The process according to claim 11, wherein the pH of the leach slurry is in the range of 3.5-4.5.

16. The process according to claim 14, wherein the alkaline agent may be any one or a combination of limestone, lime, alkali hydroxides, alkali carbonates, alkali bicarbonates, alkaline earth oxides, alkaline earth hydroxides, alkaline earth carbonates, alkaline earth bicarbonates and mixtures of thereof.

17. The process according to claim 6, further including the step of stripping the resin of sorb non-ferrous metals using acidic or ammoniacal solution to form an eluate of valuable metals.

18. The process according to claim 17, whereby when the stripping agent is an acid, the concentration of the acid is in the range of 0.5M-5.0M

19. The process according to claim 17, whereby when the stripping agent is an ammoniacal solution, the solution ranges from 15 to 25% ammonia and from 15-25% carbon dioxide.

20. The process according to claim 17, wherein resin stripped of non-ferrous metals is re-used in the step of selectively sorbing non-ferrous metals.

21. The eluate produced according to the process defined in claim 17.
